(19) United States
(12) Patent Application Publication
(10) Pub. No.: US 2022/0363258 A1
(43) Pub. Date: Nov. 17, 2022

(54) METHOD FOR OPERATING A DRIVING ASSISTANT FOR AUTOMATIC LATERAL GUIDANCE

(71) Applicant: Robert Bosch GmbH, Stuttgart (DE)

(72) Inventor: Yixuan Voigt, Stuttgart (DE)

(21) Appl. No.: 17/661,699

(22) Filed: May 2, 2022

(30) Foreign Application Priority Data
May 11, 2021 (DE) 10 2021 204 793.9

(51) Int. Cl. B60W 30/18; B60W 30/12; B60W 30/16; B60W 30/095; B60W 40/04

(52) U.S. Cl. CPC B60W 30/18163; B60W 30/12; B60W 30/16; B60W 30/0956; B60W 40/04; B60W 2554/406; B60W 2554/80; B60W 2555/80

(57) ABSTRACT

A method for operating a driving assistant for the automated lateral guidance of a motor vehicle. The method includes: executing an automated lane guidance of the motor vehicle in a first traffic lane; ascertaining a hindrance situation of a further motor vehicle due to the motor vehicle; decision for the automated lane opening of the first traffic lane taking the hindrance situation into account; executing an automated lane change into a second traffic lane for opening the lane; executing an automated lane guidance in the second traffic lane after opening the lane. A device for carrying out the method is also described.

### CROSS REFERENCE

The present application claims the benefit under 35 U.S.C. § 119 of German Patent Application No. DE 10 2021 204 793.9 filed on May 11, 2021, which is expressly incorporated herein by reference in its entirety.

### BRIEF SUMMARY

The present invention relates to a method for operating a driving assistant for the automated lateral guidance of a motor vehicle. In accordance with an example embodiment of the present invention, the method includes: executing an automated lane guidance of the motor vehicle in a first traffic lane; ascertaining a hindrance situation of a further motor vehicle due to the motor vehicle; decision for the automated lane opening of the first traffic lane, taking the hindrance situation into account; executing an automated lane change into a second traffic lane for opening the lane; executing an automated lane guidance in the second traffic lane after opening the lane. The present invention further relates to a device for carrying out the method.

### BACKGROUND INFORMATION

Lane change assistants are conventional in the related art. When a driver indicates the intention to change lanes by setting the turn signal or by a steering maneuver, the lane change assistant generates as a function of the ascertained risk value a warning signal, for example, in the form of an acoustic signal or in the form of a visual display on the dashboard or in the left exterior mirror. German Patent Application No. DE 10 2005 023 185 A1, for example, describes a lane change assistant for motor vehicles, including a monitoring unit for monitoring the traffic ahead and in the rear area of the ego vehicle and a decision unit for deciding whether a safe lane change is possible.

Automated longitudinal controls, also referred to as adaptive cruise control (ACC), are also conventional in the related art. In the case of ACC, the speed of the motor vehicle, for example, is adapted to a maximum speed or to the traffic. The lateral control in this case is assumed by the driver.

An automated lateral guidance in the form of following a lane course is made possible, for example, by a so-called lane center guidance assistant. A so-called highway assist is able to assume both the automatic longitudinal control as well as to a certain degree the lateral control, in order to follow the lane course of a thruway. Approaches are also found in the research for the complete assumption of the driving task and fully-automated, autonomous driving (so-called Level 5).

### SUMMARY

The method and device according to the present invention advantageously enable a need-based lane opening. In this way, a safe (semi-)automated guidance of a motor vehicle on multi-lane roads is made possible. The risk of rear-end collision accidents, in particular, is thereby reduced. This also results in an optimal utilization of the available road resources and in a reduction in tail-backs of following faster vehicles due to an avoidance of a blocked lane. A “human” behavior is also replicated by the described (semi-) automated driving of the motor vehicle since it is considered as a general consensus and as a rule desirable for other road users not to be unnecessarily hindered. The function therefore results in an increased acceptance on the part of the user. This results, in turn, in a more frequent application, and thus in an enhanced unburdening of the driver, as well as in the reduced likelihood of an accident.

This is made possible according to the present invention by the features disclosed herein. Example embodiments of the present invention are disclosed herein.

The method according to an example embodiment of the present invention for operating a driving assistant for the automated lateral guidance of a motor vehicle includes the following method steps: executing an automated lane guidance of the motor vehicle in a first traffic lane; ascertaining a hindrance situation of a further motor vehicle due to the motor vehicle; decision for the automated lane opening of the first traffic lane, taking the hindrance situation into account; executing an automated lane change into a second traffic lane for opening the lane; executing an automated lane guidance in the second traffic lane after opening the lane.

This is understood to mean a driver assistance function, which is made possible in (semi-)automated driving. The driver assistance function supports the driver with the aid of an automated lane guidance and expands this driver support, in that a need-based lane opening is recognized and carried out in an automated manner. For this purpose, the driving situation of the motor vehicle is analyzed and assessed.

For this purpose, video data or/and radar data relating to the vehicle surroundings, for example, may be ascertained. In the process, it is analyzed whether a hindrance situation is present, in which the ego vehicle is hindering the further traffic. This means, the instantaneously present traffic situation of the motor vehicle is ascertained, for example, taking at least one piece of information of a surroundings detection system, for example, of a camera, of the motor vehicle into account, at least one piece of information of a road user to the rear with respect to the motor vehicle in the present traffic lane of the motor vehicle being taken into account. Alternatively or in addition, a car-to-car communication and/or a car-to-infrastructure communication may also be used in order to obtain pieces of information regarding a hindrance situation, or to ascertain a hindrance situation taking these pieces of information into account.

A decision for the automated lane opening then takes place when the hindrance situation corresponds to a defined characteristic.

For example, a lane opening takes place when the hindrance of the traffic to the rear caused by the motor vehicle takes on a certain relevance, for example. In this case, a lane change takes place from the present traffic lane into a further traffic lane.

Both traffic lanes are understood to be unidirectional, i.e., in the same driving direction. The method is therefore advantageously used on roadways that include multiple, unidirectional traffic lanes. Furthermore, the second traffic lane is advantageously directly adjacent to the first traffic lane, so that no change across multiple traffic lanes is required to be assessed. This further increases the validity of the results and thus the safety of the automated driving function. In addition, the lane opening advantageously takes place via a change into a traffic lane with a slower control speed, i.e., “to the right” in right-hand traffic or “to the left” in left-hand traffic.

In one advantageous embodiment of the present invention, in the method, the hindrance situation is ascertained when at least one of the following conditions is met: a distance between the motor vehicle and the following further motor vehicle falls below a threshold value; a difference in speed between the motor vehicle and the following further motor vehicle exceeds a threshold value; a difference in acceleration between the motor vehicle and the following further motor vehicle exceeds a threshold value.

This is understood to mean that the hindrance situation is recognized as such when the hindrance situation corresponds to a defined characteristic. This is the case, for example, when the motor vehicle represents a hindrance of a further motor vehicle directly following the motor vehicle in the same traffic lane, a threshold value for at least one defined variable being taken into account for ascertaining the hindrance. Defined variables include: for example, a distance between the motor vehicle and the following further motor vehicle; and/or a difference in speed between the motor vehicle and the following further motor vehicle (i.e., relative speed) and/or a difference in acceleration between the motor vehicle and the following further motor vehicle (i.e., relative acceleration). A relative speed or a relative acceleration is understood to mean, in particular, a variable, which allows the distance between the ego vehicle and the following traffic to become shorter over time. For example, a decision for the automated lane opening takes place when the distance of a following automobile relative to the ego vehicle falls below a set minimal distance.

The threshold value (or the threshold values) is/are advantageously settable, for example, manually by the driver or by selection of a specific function (for example, sport-driving mode or comfort-driving mode, etc.).

In one possible example embodiment of the present invention, the method includes the following method steps: ascertaining a lane opening situation and/or a decision for the automated lane opening taking the lane opening situation into account.

This is understood to mean that the instantaneous driving situation is analyzed in terms of whether a lane opening may or should take place. This means, the instantaneously present traffic situation of the motor vehicle is ascertained taking at least one piece of information of a surroundings detection system into account. Based on the ascertained data, the instantaneously present driving situation is assessed. It is further ascertained whether the ego vehicle in the instantaneously present driving situation should open its traffic lane in accordance with stored factors or scenarios. A positive decision for an automated lane opening accordingly takes place when the present traffic situation represents both a hindrance situation according to the defined (first) characteristic as well as a lane opening situation according to the defined (second) characteristic.

In one preferred embodiment of the present invention, in the method, the lane opening situation is ascertained when at least one of the following conditions is met: a change of the motor vehicle into the second traffic lane is possible; a change of the following motor vehicle into an alternative lane is not possible; a change of the motor vehicle into the second traffic lane avoids a hindrance of the following motor vehicle in the first traffic lane, in particular, for at last a defined driving distance.

This is understood to mean that the lane opening situation is recognized as such when this corresponds to a defined characteristic. This is the case, for example, if the motor vehicle is in a specific driving situation, in which, for example, according to rules (or conditions) stored in the vehicle, the motor vehicle should open its lane. That a change of the ego vehicle into a second traffic lane must be possible may be advantageously defined as one such rule. A second traffic lane may be considered to be a traffic lane that tends to be slower, for example. A change into this traffic lane is possible only if this traffic lane is not already directly (or also at a short distance) occupied by a further vehicle. That a change of the following motor vehicle i.e., of the blocked motor vehicle into an alternative lane is not possible may also be defined as a rule. An alternative lane may be considered to be a traffic lane that tends to be faster, for example. A change of the blocked motor vehicle into such an alternative traffic lane may not be possible if, in principle, no such alternative traffic lane is available, or such a traffic lane is occupied by a further vehicle. That a possible change of the ego motor vehicle into the second traffic lane in fact also eliminates the hindrance of the following motor vehicle may further be defined as a rule. If a further, potentially even slower vehicle is situated, for example, directly ahead of the ego motor vehicle, a lane opening of the ego motor vehicle would not result in any improvement of the driving situation for the blocked following vehicle. As a result, a lane opening by the ego vehicle does not appear constructive and therefore appears unnecessary.

In one alternative refinement, the method includes the method steps: ascertaining a lane opening option situation; decision for the automated lane opening taking the lane opening option situation into account.

This is understood to mean that the instantaneous driving situation is analyzed in terms of whether a lane change for a lane opening can or may even take place. In this case, building structures of the driving surroundings may be taken into account, for example, the presence of a second traffic lane for a lane change. General situation-specific aspects, for example, the instantaneous speed of the motor vehicle, may further be taken into account up to and including aspects of road traffic law, such as established lane change prohibitions. This means, the instantaneously present traffic situation of the motor vehicle, for example, is ascertained. Based on the ascertained data, the instantaneously present driving situation is assessed. It is further ascertained whether the ego vehicle in the instantaneously present driving situation would be able to execute a lane change for opening a lane according to stored factors or rules. A positive decision for an automated lane opening accordingly takes place only when the present traffic situation corresponds to a lane opening option situation according to the defined (third) characteristic and also represents a hindrance situation according to the defined (first) characteristic.

In one possible specific embodiment of the present invention, in the method, the lane opening option situation is taken into account as a prerequisite for the decision regarding the automated lane opening, in particular, that the lane opening option situation is taken into account a prerequisite for an ascertainment of the hindrance situation and/or as a prerequisite for an ascertainment of a lane opening situation.

This is understood to mean that the assessment of the lane opening option situation takes place prior to the decision regarding the automated lane opening. This means, it is initially checked whether the lane opening option situation corresponds to a defined characteristic. Only after a positive check of this aspect has taken place is a decision made regarding an automated lane opening. In one advantageous embodiment, the ascertainment of the hindrance situation is carried out only when a positive check of the lane opening option situation has taken place. Furthermore, the ascertainment of the lane opening situation as well may be carried out only when a positive check of the lane opening option situation has taken place. In this way, the evaluation process may be advantageously sequentially configured. Computing capacity may be saved and the quality of results may be improved as a result.

In one preferred embodiment of the present invention, in the method, the lane opening option situation is ascertained when at least one of the following conditions is met: a speed of the motor vehicle exceeds a defined first threshold value; a speed of the motor vehicle does not exceed a defined second threshold value; the second traffic lane is a lower-speed traffic lane; there is no prohibition for a change from the first traffic lane to the second traffic lane; the motor vehicle is not situated on a traffic lane that is situated second from the outside on a three-lane or multi-lane road outside built-up areas.

This is understood to mean that the lane opening option situation is recognized as such when the latter corresponds to a defined characteristic. This is the case, for example, when the motor vehicle is in a driving situation, in which, for example, according to rules (or conditions) stored in the vehicle, a lane opening appears executable in principle. That the speed of the motor vehicle is to reach a defined minimum speed may be advantageously defined as one such rule. For example, a low speed indicates a high traffic volume. In such a case, a decision regarding an automated lane opening may be suspended. That a defined maximum speed may not be exceeded may be defined as a further rule. At high speeds, any lane change is associated with a heightened risk, since there is less response time available. In such a case, a decision regarding an automated lane opening may be suspended. That no prohibition for a lane change is present may be defined as a further rule. Such a prohibition is present, for example, at critical driving points in order to reduce the risk of an accident. Such a prohibition may be marked by traffic signs, solid roadway separators and may be recognized by the video camera. Such a prohibition is also storable and removable, for example, in digital road maps. Furthermore, negated conditions may also be formulated in order, for example, to suspend an automated lane opening in situations, in which, for example, exceptions to the drive-on-the-right requirement exist. Thus, according to road traffic regulations in Germany, for example, no drive-on-the-right requirement applies on a middle lane of a three-lane or multi-lane road (in particular, expressway) outside of built-up areas. One condition may be advantageously formulated, according to which the driving maneuver option situation in such a situation does not correspond to the required characteristic and accordingly no decision regarding a possible lane opening is carried out.

In one alternative embodiment of the present invention, in the method, a data signal is generated, with the aid of which a vehicle operator of the vehicle may be informed regarding the decided lane opening with the aid of an automated lane change into the second traffic lane.

This is understood to mean that technical preparations are made, in order to inform the driver about the impending lane opening. For this purpose, data signals are coded and provided accordingly. With the aid of the data signals, output devices may be activated, which provide a corresponding piece of information to the driver. The piece of information in this case may be communicated visually, for example, with the aid of HMI, to the driver or, for example, acoustically with the aid of voice output. Haptic pieces of information such as single-sided seat vibrations are, of course, also possible. The driver is advantageously informed about the planned automated lane opening by a corresponding setting of the turn signal. As a result of the timely piece of information regarding the planned driving maneuver, the driver is advantageously given the opportunity to prevent an automated execution if he/she so desires.

In one advantageous refinement of the present invention, in the method, a data signal is generated, with the aid of which surroundings of the motor vehicle may be informed regarding the decided lane opening with the aid of an automated lane change into the second traffic lane. By setting the turn signal accordingly, the further road users, for example, the blocked following vehicle or the vehicle in the second traffic lane, are advantageously informed about the planned automated lane change.

In one possible embodiment of the present invention, in the method, an execution of the decided lane opening takes place with the aid of an automated lane change into the second traffic lane if no refusal of the decided lane opening by the vehicle operator of the motor vehicle is ascertained, in particular, when within a defined time span after a notification to the driver regarding the decided lane opening with the aid of an automated lane change into the second traffic lane, no refusal of the decided lane opening by the vehicle operator of the motor vehicle is ascertained.

This is understood to mean that an automated lane change into the second traffic lane takes place only when no refusal of the lane change by a vehicle operator (in particular, the driver) of the motor vehicle is ascertained. A refusal by the vehicle operator to change lanes may take place prior to the execution of the lane change, for example, when the driver prevents a start of the driving maneuver via command input, for example, by switching off the set turn signal, immediately after the notification about the intended lane opening. A refusal to change lane may, of course, take place also during the execution of the lane change (i.e., a stop of the initiated lane change process), for example, by taking hold of the steering wheel and steering back onto the first lane. An automated execution of the lane opening may also take place when no driver response takes place. The automated lane change advantageously takes place if no negative input of the vehicle operator, or no contrary input of the vehicle operator is ascertained. Thus, the execution of the automated lane opening requires no positive confirmation by the driver.

An automated lane change into the second traffic lane advantageously takes place when within a defined time span after a notification to the driver regarding the decided automated lane change, no refusal by the driver to change lanes is ascertained. This means, that after the communication of the intended lane opening, the execution of the lane opening does not immediately take place. Instead, a driver response is awaited within a defined time span. The defined time span is advantageously calculated in such a way that it takes a normal perception time, response time and decision time into account. If during this time no input or at least no negative input of the driver is ascertained, an initiation of the automated lane change process takes place. In this case, a stop of the automated lane change process by the driver is possible at any time.

In one advantageous alternative, an execution of the decided lane opening with the aid of an automated lane change into the second traffic lane takes place only when a confirmation of the lane change by the driver is ascertained. In one advantageous embodiment of the present invention, an execution of the decided lane opening with the aid of an automated lane change into the second traffic lane takes place only when within a defined time span after a notification to the driver regarding the decided automated lane change, a confirmation of the lane change by the driver is ascertained. In this way, the safety may be advantageously enhanced. A confirmation of the lane change by the driver may take place, for example, with the aid of actuation of a confirmation push button at the steering wheel or also by voice command or in any other possible way.

This method may be implemented, for example, in software or in hardware or in a mixed form of software and hardware, for example, in a control unit. The approach presented here further provides a device, which is designed to carry out, activate, or implement the steps of a variant of a method presented here in corresponding units. With this embodiment variant of the present invention in the form of a device as well, it is possible to quickly and efficiently achieve the object underlying the present invention.

A device in the present case may be understood to mean an electrical device, which processes sensor signals and, as a function thereof, outputs control signals and/or data signals. The device may include an interface, which may be designed in hardware and/or in software. In a hardware design, the interfaces may, for example, be part of a so-called system ASIC, which contains various functions of the device. It is also possible, however, for the interfaces to be separate, integrated circuits or to be made at least partly of discrete components. In a software design, the interfaces may be software modules, which are present, for example, on a microcontroller alongside other software modules. A device may therefore include a motor vehicle, a driver assistance system for automated lateral guidance and/or transverse guidance for a motor vehicle, a surroundings detection device, in particular, a camera, a LIDAR and/or a radar, an actuator system, in particular an actuator system for automated lateral control and/or longitudinal control, a centralized or decentralized control unit for executing one of the aforementioned devices.

Also advantageous is a computer program product or computer program having program code, which may be stored on a machine-readable medium or memory medium, such as a semiconductor memory, a hard disk memory or an optical memory, and which is used for carrying out, implementing and/or activating the steps of the method according to one of the previously described specific embodiments, in particular, when the program product or program is executed on a computer or a device.

It should be noted that the features individually cited in the description may be combined with one another in an arbitrary, technically meaningful manner and highlight further embodiments of the present invention. Further features and usefulness of the present invention result from the description of exemplary embodiments with reference to the accompanying drawings.

### BRIEF DESCRIPTION OF THE DRAWINGS

FIGS. 1A through 1C schematically show a representation of a sequence of one example embodiment of the method in a specific traffic situation, in accordance with an example embodiment of the present invention.

FIGS. 2A through 2B show a representation of the method steps of one specific embodiment of the present invention.

### DETAILED DESCRIPTION OF EXAMPLE EMBODIMENTS

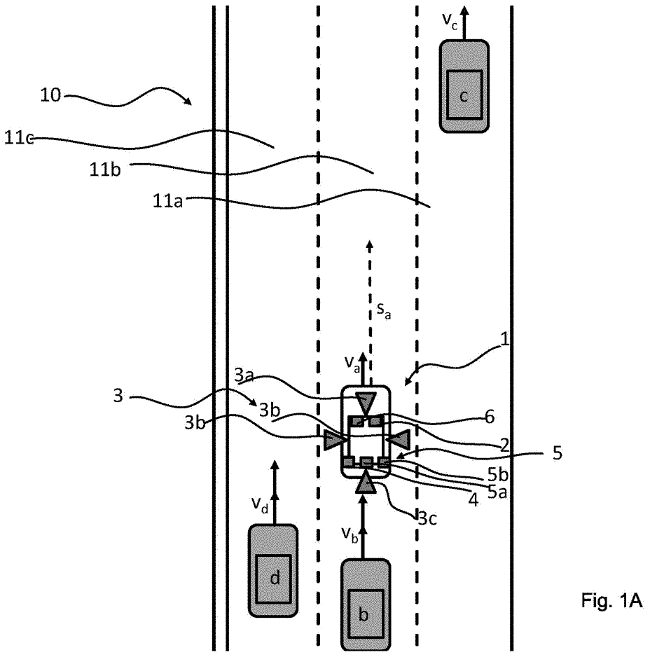

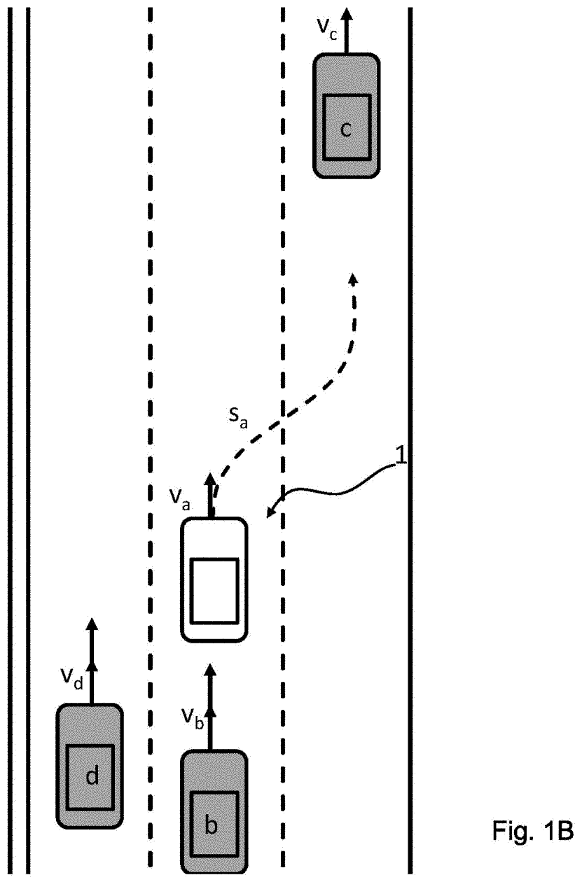

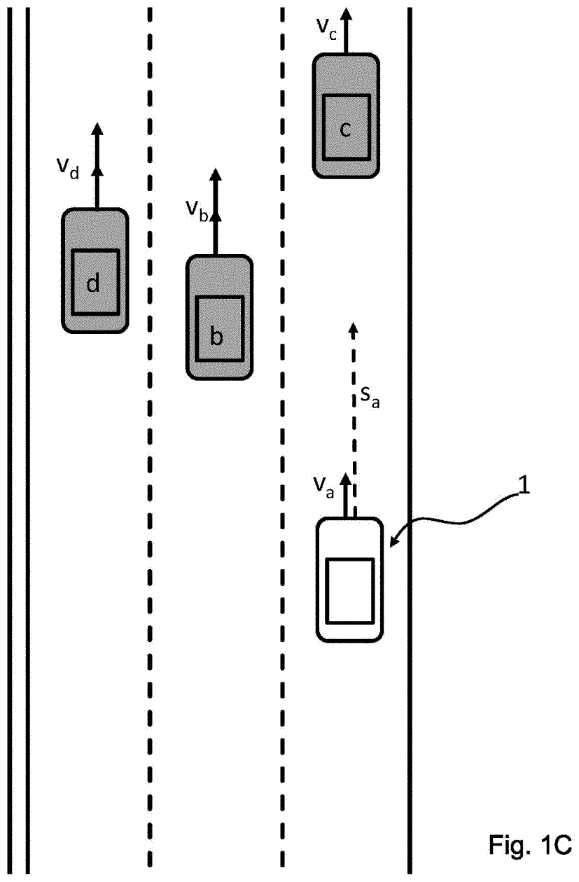

FIGS. 1A-1C schematically show a representation of a sequence of one embodiment of the method in a specific traffic situation, represented in three sequences.

FIG. 1A in this representation shows the starting situation. A motor vehicle 1 (also referred to as ego vehicle) is shown on a roadway 10. Roadway 10 in this case includes three traffic lanes: right traffic lane 11a, middle traffic lane 11b and left traffic lane 11c. Motor vehicle 1 includes a driver assistance system 2. The latter is designed as a driving assistant for automated lane guidance. A sensor system 3 for surroundings detection is also represented. The sensor system includes a sensor 3a for front surroundings detection (for example, a front camera), a sensor 3b for rear surroundings detection (for example, a rear camera), as well as multiple sensors 3c for side surroundings detection (for example, side cameras). In this case, radar, LIDAR or other suitable sensor types may, of course, alternatively or additionally also be used. Motor vehicle 1 further includes a processing unit 4 (also control unit) for evaluating the sensor data and/or for carrying out the method and/or for activating the actuators. Motor vehicle 1 further includes an actuator system 5. This system is made up, for example, of an actuator 5a for lateral control as well as an actuator 5b for longitudinal control. A device 6 is further configured for informing the driver. This device may, for example, communicate pieces of information to the driver in a visual and/or acoustic and/or haptic manner.

Motor vehicle 1 in the representation moves on driving trajectory sₐ at speed Vₐ. In the traffic situation represented, further road users in addition to motor vehicle 1 are situated on roadway 10: a vehicle b at a higher driving speed V_{b} is situated in the same middle traffic lane 11b behind ego vehicle 1. A vehicle c at approximately the same speed V_{c} as speed Vₐ of the ego vehicle a is situated on right traffic lane 11a in the driving direction ahead of ego vehicle 1. A further vehicle d is situated on left traffic lane 11c at approximately the height of vehicle b. Vehicle d is driving at speed V_{d}, which is similar to V_{b} and is increased as compared to Vₐ.

FIG. 1B in this case shows the intermediate situation. Ego vehicle 1 has ascertained the hindrance situation caused by itself and has made a decision for automated lane opening. In the process, the traffic situation behind ego vehicle 1 (in particular, distance and acceleration difference between ego vehicle 1 and vehicle b) has been taken into account, and the traffic situation ahead of the ego vehicle (in particular, the distance and acceleration difference between ego vehicle 1 and vehicle c) has been analyzed. In the process, it has been ascertained that a lane change is situationally possible and correspondingly pre-set criteria appear to be suitable. Thus, an automated lane change to the right lane is initiated. Driving trajectory sₐ already shows the planned lane change of ego vehicle 1 from traffic lane 11b to traffic lane 11a.

FIG. 1C in this case shows the final situation. Ego vehicle 1 has executed the automated lane change into a second traffic lane 11a and now continues to execute the automated lane guidance in second traffic lane 11a after the executed lane change. Accordingly, driving trajectory sₐ is directed straight ahead. In the meantime, vehicles b and d have passed ego vehicle 1 due to the higher speed and the advanced time.

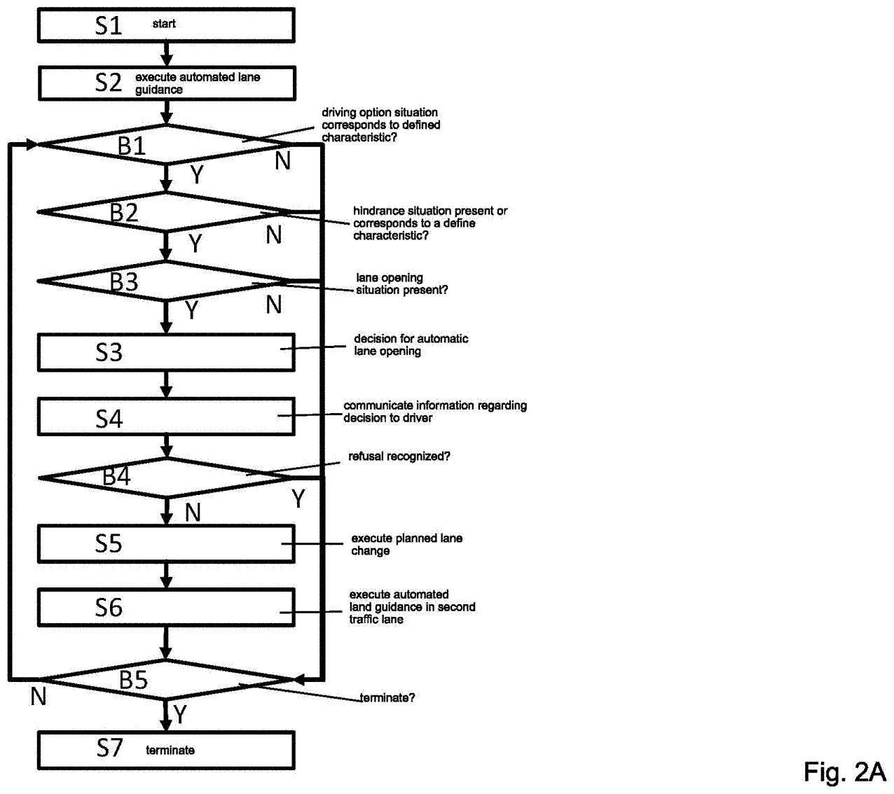

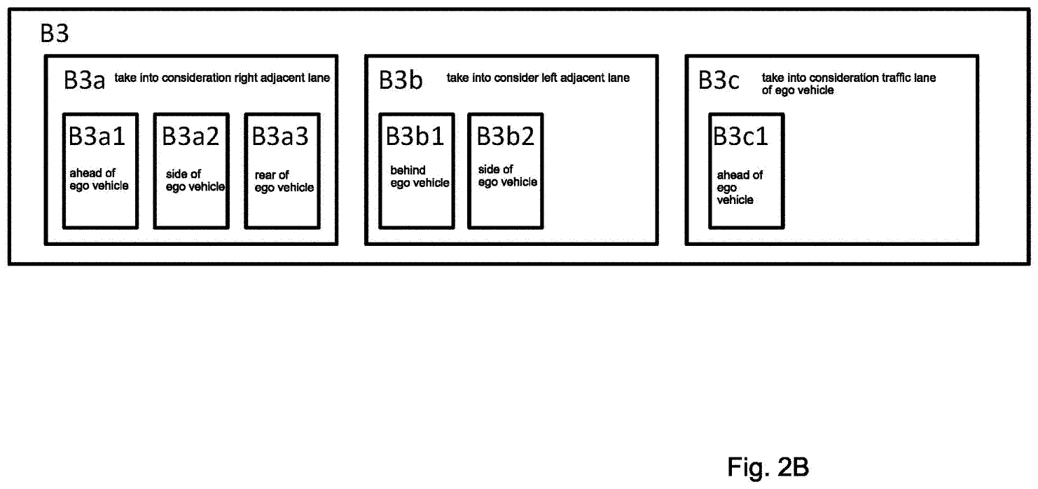

FIGS. 2A-2B show a representation of the method steps of one specific embodiment of the present invention. FIG. 2A shows an overview representation, whereas FIG. 2B shows step B3 in detail and more finely subdivided.

In FIG. 2A, the start of the method takes place in a first step S1. The execution of the automated lane guidance in the first traffic lane takes place in a step S2. For example, the automated lane guidance is activated by the driver of the motor vehicle. In a following condition B1, it is checked whether a driving option situation corresponds to a defined characteristic. For this purpose, surroundings data are ascertained and analyzed, for example, as to whether the instantaneous driving situation corresponds to a particular condition. In this case, it is checked, in particular, whether in the instantaneous driving situation the optional possibility of executing a specific driving maneuver, in particular, a lane change, even exists. For example, it is checked whether a further traffic lane is even present to the right of the present traffic lane. It may also be checked whether the speed of the ego vehicle is not too high. A lane change at excessively high speeds is associated with a higher risk. It may therefore be provided that no automated lane opening takes place above an adjustable speed threshold.

If the driving option situation corresponds to a defined characteristic (Y-branch), i.e., a lane opening is possible in principle, it is checked in a second condition B2 whether a hindrance situation is present or whether a hindrance situation corresponds to a defined characteristic.

In this case, for example, the traffic situation to the rear is monitored. The traffic situation directly behind the ego vehicle is, in particular, taken into account. In this case, it is checked, for example, whether a vehicle is driving in the same lane behind ego vehicle. In one first embodiment, a need-based lane opening may take place when a further vehicle is recognized at a defined distance behind the ego vehicle. Alternatively or in addition, the speed or the difference in speed between the two vehicles may also be taken into account. Furthermore, the acceleration and/or differences in acceleration between this vehicle and the ego vehicle may be ascertained. In this way, it may be ascertained whether the ego vehicle would represent a hindrance in an extrapolated continuation of travel of the catching-up vehicle. It is further possible that the driver has an adjustment option in order, for example, to change the sensitivity of the lane opening. Thus, it is possible that with the aid of adjusting, the driver is able to influence the trigger thresholds, in particular, the distance between the ego vehicle and the following vehicle and/or their relative speeds, in order to configure an execution of the function, in particular, to configure a temporary opening of the present lane with the aid of a lane change, for his/her needs.

For the method, the surroundings of the vehicle are monitored with the aid of a sensor system. In this case, a front camera and/or a rear sensor (for example, rear radar, rear camera or rear LIDAR) and/or surround sensor (for example, a 360° video system, corner radar), in particular, may be used. The ascertainment of the data with the aid of the sensor system may take place as a separate step within the framework of the method. With the aid of a control unit, it is subsequently evaluated whether a lane opening is required and possible. In this case, for example, the control unit may be a central processor control unit or a control unit of the sensor system, of an actuator, or the functionalities additionally implemented on such an actuator.

If the hindrance situation corresponds to a defined characteristic (Y-branch), i.e., a defined hindrance is actually present, it is checked in a further condition B3 whether a lane opening situation is present. In one embodiment, the system may monitor the general traffic situation and execute a situationally-adaptive lane opening. This means that a lane opening recommendation is ascertained and implemented in an automated manner only in defined traffic situations. An ascertainment of a lane opening decision takes place, in particular, if another road user were to be hindered as a result of maintaining the present traffic lane and a lane opening by the ego vehicle is able to be executed without significantly forfeiting driving comfort and driving safety and without significant influence on the efficiency. Possible embodiments are described in detail in FIG. 2B.

Here, too, it is possible that a driver setting with respect to the severity of the determination criteria may be carried out. In the case of a correspondingly changed setting, lane opening recommendations would be correspondingly more frequently or less frequently output.

If the lane opening situation corresponds to a defined characteristic (Y-branch), i.e., a lane opening in the present situation should be executed taking the ascertained criteria into account, a decision for automatic lane opening is made in a next step S3.

The piece of information regarding the decided, i.e. imminent, automated lane opening is subsequently communicated to the driver in a step S4. This means, the imminent interruption of the lane guidance function and/or the planned driving maneuver is communicated to the driver with the aid of a communication device. In this case, an acoustic and/or haptic and/or visual output or physical contact (such as vibration) at the driver, for example, may take place. An automated setting of the turn signal in the planned lane change direction may also be used in this case.

The driver may also be provided the opportunity to prevent the planned driving maneuver and instead to continue to execute the instantaneous automated lane guidance function. After the notification to the driver, it is checked in a condition B4 whether a refusal of the planned automated lane change by the driver is recognized. For example, an acoustic objection of the driver may be ascertained. A deactivation of the set turn signal may also be considered to be a refusal. Condition B4 may, for example, be associated with a temporal threshold, so that, for example, a defined time period is awaited as to whether a negative response of the driver is ascertained. A defined time period may be defined, for example, as 2 to 5 seconds. If no response, or at least no negative response, of the driver is ascertained, it may be assumed that no refusal of the driver regarding the planned automated lane change is present.

If no refusal of the planned automated lane change is ascertained, the planned lane change is executed in an automated manner in step S5 and the motor vehicle changes from the first traffic lane into the second traffic lane. An execution of the automated lane guidance in the second traffic lane subsequently takes place in a step S6. In a subsequent condition B5, it is checked whether a termination of the method is present. If this is the case (Y-branch), then the method is terminated in step S7. If this is not the case (N-branch), an analysis of the instantaneous driving option situation again takes place.

One embodiment of the analysis of lane opening situation B3 is represented in detail in FIG. 2B.

In this case, the right adjacent lane (or left adjacent lane in left-hand traffic) may be taken into account with the aid of B3a. With the aid of B3a1, the traffic lane section in the driving direction ahead of the ego vehicle may be taken into account and/or with the aid of B3a2, the traffic lane section to the side of the ego vehicle may be taken into account. In this case, it may, for example, be checked whether the ego vehicle is able to execute a lane change to the right (or to the left in left-hand traffic). In addition to the pure technical feasibility, the feasibility may be assessed, in particular, taking into account aspects such as driving comfort (for example, avoiding the need to brake with high deceleration, “severe braking”), driving safety (for example, providing sufficient distance) and also resource efficiency (for example, change of fuel consumption or CO2 output as a result of brake application and subsequent acceleration). The right adjacent lane in the driving direction to the rear of the ego vehicle may, of course, also be taken into account with the aid of B3a3. In this case, it may be checked whether a lane change to the right is possible, or whether a vehicle in the right traffic lane is approaching from behind and thus making a safe lane change impossible.

Furthermore, the left adjacent lane (or right adjacent lane in right-hand traffic) may be taken into account with the aid of B3b. In this case, the traffic lane section in the driving direction behind the ego vehicle may be taken into account with the aid of B3b1 and/or to the side of the ego vehicle with the aid of B3b2. It may be checked in this case, for example, whether the catching-up vehicle itself is able to execute a lane change to the left (or to the right in right-hand traffic), or whether this lane is blocked by a further road user. If the catching-up vehicle itself is able to execute a lane change without difficulty, then there is no need or less need for a lane opening by the ego vehicle and there is a correspondingly reduced ascertainment of a lane opening recommendation.

The traffic lane of the ego vehicle may also be further taken into account in detail with the aid of B3c. In this case, the traffic lane section in the driving direction ahead of the ego vehicle may be taken into account with the aid of B3c1. If this lane is occupied by one or multiple vehicles at approximately the same speed as the ego vehicle, then there is no need or only less need for a lane opening by the ego vehicle, since the faster following vehicle would likely be promptly blocked on this lane.

What is claimed is:

1. A method for operating a driving assistant for the lateral guidance of a motor vehicle, comprising the following steps:
executing an automated lane guidance of the motor vehicle in a first traffic lane;
ascertaining a hindrance situation of a following further motor vehicle due to the motor vehicle;
deciding for an automated lane opening of the first traffic lane taking the hindrance situation into account;
executing the decided lane opening using an automated lane change into a second traffic lane; and
executing an automated lane guidance in the second traffic lane after opening the lane.

2. The method as recited in claim 1, wherein the hindrance situation is ascertained when at least one of the following conditions is met:
a distance between the motor vehicle and the following further motor vehicle falls below a threshold value;
a difference in speed between the motor vehicle and the following further motor vehicle exceeds a threshold value;
a difference in acceleration between the motor vehicle and the following further motor vehicle exceeds a threshold value.

3. The method as recited in claim 1, further comprising:
ascertaining a lane opening situation;
wherein the decision for the automated lane opening takes the lane opening situation into account.

4. The method as recited in claim 3, wherein the lane opening situation is ascertained when at least one of the following conditions is met:
a change of the motor vehicle into the second traffic lane is possible;
a change of the following further motor vehicle into an alternative lane is not possible;
a change of the motor vehicle into the second traffic lane prevents a hindrance of the following further motor vehicle in the first traffic lane for at least a defined driving distance.

5. The method as recited in claim 1, further comprising the following steps:
ascertaining a lane opening option situation;
wherein decision for the automated lane opening takes the lane opening option situation into account.

6. The method as recited in claim 5, wherein the lane opening option situation is taken into account as a prerequisite for the decision regarding the automated lane opening, the lane opening option situation being taken into account as a prerequisite for the ascertainment of the hindrance situation and/or as a prerequisite for the ascertainment of a lane opening situation.

7. The method as recited in claim 5, wherein the lane opening option situation is ascertained when at least one of the following conditions is met:
a speed of the motor vehicle exceeds a defined first threshold value;
a speed of the motor vehicle does not exceed a defined second threshold value;
the second traffic lane is a lower-speed traffic lane;
there is no prohibition present for a change from the first traffic lane into the second traffic lane;
the motor vehicle is not situated on a traffic lane that is located second from the outside on a three-lane or multi-lane road outside of built-up areas.

8. The method as recited in claim 1, wherein a data signal is generated, using which a vehicle operator of the motor vehicle is informed regarding the decided lane opening using the automated lane change into the second traffic lane.

9. The method as recited in claim 1, wherein a data signal is generated using which surroundings of the motor vehicle are informed regarding the decided lane opening using the automated lane change into the second traffic lane.

10. The method as recited in claim 1, wherein an execution of the decided lane opening takes place using the automated lane change into the second traffic lane when no refusal of the decided lane opening by a vehicle operator of the motor vehicle is ascertained, when within a defined time span after a notification to a driver regarding the decided lane opening with using the automated lane change into the second traffic lane, no refusal of the decided lane opening by the vehicle operator of the motor vehicle is ascertained.

11. A device for operating a driving assistant for the lateral guidance of a motor vehicle, the device configured to:
execute an automated lane guidance of the motor vehicle in a first traffic lane;
ascertain a hindrance situation of a following further motor vehicle due to the motor vehicle;
decide for an automated lane opening of the first traffic lane taking the hindrance situation into account;
execute the decided lane opening using an automated lane change into a second traffic lane; and
execute an automated lane guidance in the second traffic lane after opening the lane.

12. A non-transitory computer-readable medium on which is stored a computer program for operating a driving assistant for the lateral guidance of a motor vehicle, the computer program, when executed by a processor, causing the processor to perform the following steps:
executing an automated lane guidance of the motor vehicle in a first traffic lane;
ascertaining a hindrance situation of a following further motor vehicle due to the motor vehicle;
deciding for an automated lane opening of the first traffic lane taking the hindrance situation into account;
executing the decided lane opening using an automated lane change into a second traffic lane; and
executing an automated lane guidance in the second traffic lane after opening the lane.
